(19) United States
(12) Patent Application Publication
(10) Pub. No.: US 2026/0263927 A1
(43) Pub. Date: Sep. 10, 2026

(54) INTERACTION PROCESSING METHOD AND APPARATUS FOR VIRTUAL SCENE, DEVICE, MEDIUM, AND PROGRAM PRODUCT

(71) Applicant: TENCENT TECHNOLOGY (SHENZHEN) COMPANY LIMITED, Shenzhen (CN)

(72) Inventor: Ziyi WANG, Shenzhen (CN)

(21) Appl. No.: 19/547,127

(22) Filed: Feb. 23, 2026

Related U.S. Application Data
(63) Continuation of application No. PCT/CN2024/109896, filed on Aug. 5, 2024.

(30) Foreign Application Priority Data
Nov. 13, 2023 (CN) 202311514960.5

(51) Int. Cl. A63F 13/52; A63F 13/533; A63F 13/5372; A63F 13/5378

(52) U.S. Cl. CPC A63F 13/52; A63F 13/533; A63F 13/5372; A63F 13/5378

(57) ABSTRACT

An interaction processing method performed by an electronic device includes displaying a virtual scene on a human-computer interaction interface. The virtual scene includes a plurality of virtual objects. The method further includes displaying an interaction range of a target virtual object of the plurality of virtual objects in the virtual scene in response to an interaction condition being satisfied. The interaction range is a range within which a virtual weapon held by the target virtual object is able to attack.

### CROSS-REFERENCE TO RELATED APPLICATIONS

This application is a continuation of International Application No. PCT/CN2024/109896, filed on Aug. 5, 2024, which claims priority to Chinese Patent Application No. 202311514960.5 filed on Nov. 13, 2023, the entire contents of both of which are incorporated herein by reference.

### FIELD OF THE TECHNOLOGY

This application relates to a computer application technology and, in particular, to an interaction processing method and apparatus for a virtual scene, an electronic device, a computer-readable storage medium, and a computer program product.

### BACKGROUND OF THE DISCLOSURE

A display technology based on graphics processing hardware expands channels for environment sensing and information obtaining. In particular, a virtual scene display technology can achieve diversified interactions between virtual objects controlled by a user or artificial intelligence according to an actual application demand, and is applicable to various typical application scenes. For example, the display technology can emulate a real interaction process between the virtual objects in a virtual scene such as a game.

In a related art, after a virtual scene starts to run, a player account corresponding to a virtual object needs to perform indirect communication by using an out-of-game guide or social software, to learn about interaction ranges (such as holding angles) of another virtual object and finally complete a battle task together. Since this interaction manner requires additional communication resources and computing resources, efficiency of human-computer interactions is poor, and a user experience is affected.

### SUMMARY

In accordance with the disclosure, there is provided an interaction processing method performed by an electronic device and including displaying a virtual scene on a human-computer interaction interface. The virtual scene includes a plurality of virtual objects. The method further includes displaying an interaction range of a target virtual object of the plurality of virtual objects in the virtual scene in response to an interaction condition being satisfied. The interaction range is a range within which a virtual weapon held by the target virtual object is able to attack.

Also in accordance with the disclosure, there is provided an electronic device including a memory storing a computer program or a computer-executable instruction, and a processor configured to execute the computer program or the computer-executable instruction to display a virtual scene on a human-computer interaction interface. The virtual scene includes a plurality of virtual objects. The processor is further configured to execute the computer program or the computer-executable instruction to display an interaction range of a target virtual object of the plurality of virtual objects in the virtual scene in response to an interaction condition being satisfied. The interaction range is a range within which a virtual weapon held by the target virtual object is able to attack.

Also in accordance with the disclosure, there is provided a non-transitory computer-readable storage medium storing a computer program or a computer-executable instruction that, when executed by a processor, causes an electronic device including the processor to display a virtual scene on a human-computer interaction interface. The virtual scene includes a plurality of virtual objects. The computer program or the computer-executable instruction further causes the electronic device to display an interaction range of a target virtual object of the plurality of virtual objects in the virtual scene in response to an interaction condition being satisfied. The interaction range is a range within which a virtual weapon held by the target virtual object is able to attack.

### BRIEF DESCRIPTION OF THE DRAWINGS

FIG. 1 is a schematic diagram showing holding an angle according to an embodiment of this application.

FIG. 2A is a schematic diagram showing a first application mode of an interaction processing method for a virtual scene according to an embodiment of this application.

FIG. 2B is a schematic diagram showing a second application mode of an interaction processing method for a virtual scene according to an embodiment of this application.

FIG. 3A is a first schematic structural diagram of an electronic device for interaction processing according to an embodiment of this application.

FIG. 3B is a second schematic structural diagram of an electronic device for processing an interaction according to an embodiment of this application.

FIG. 4A is a first schematic flowchart of an interaction processing method for a virtual scene according to an embodiment of this application.

FIG. 4B is a second schematic flowchart of an interaction processing method for a virtual scene according to an embodiment of this application.

FIG. 4C is a third schematic flowchart of an interaction processing method for a virtual scene according to an embodiment of this application.

FIG. 4D is a fourth schematic flowchart of an interaction processing method for a virtual scene according to an embodiment of this application.

FIG. 5 is a sixth schematic flowchart of an interaction processing method for a virtual scene according to an embodiment of this application.

FIG. 6A is a schematic diagram showing a “related items of angle holding” module according to an embodiment of this application.

FIG. 6B is a schematic diagram showing an angle holding range according to an embodiment of this application.

FIG. 7 is a schematic diagram showing an ant line according to an embodiment of this application.

FIG. 8A is a schematic diagram showing prompt information according to an embodiment of this application.

FIG. 8B is a schematic diagram showing a planning prompt according to an embodiment of this application.

FIG. 9 is a schematic logic diagram showing “team angle holding range” according to an embodiment of this application.

FIG. 10 is a schematic logic diagram showing “angle holding planning” according to an embodiment of this application.

FIG. 11 is a schematic logic diagram showing “intelligent planning” according to an embodiment of this application.

FIG. 12 is a region that can be covered by a team member holding an angle in an ideal case according to an embodiment of this application.

FIG. 13A is a schematic diagram showing an area that can be covered by holding an angle without an obstruction according to an embodiment of this application.

FIG. 13B is a first schematic diagram showing an area that can be covered by holding an angle with an obstruction according to an embodiment of this application.

FIG. 13C is a second schematic diagram showing an area that can be covered by holding an angle with an obstruction according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the scope of this application.

The terms, involved in the following description, “first/second/ third/fourth/fifth/sixth” are merely intended to distinguish similar objects rather than describing specific orders. “First/second/third/fourth/fifth/sixth” is interchangeable in proper circumstances to enable the embodiments of this application to be implemented in other orders than those illustrated or described herein.

In the following descriptions, “some embodiments” describes a subset of all possible embodiments. However, “some embodiments” may be the same subset or different subsets of all the possible embodiments, and the embodiments may be combined with each other without conflict.

Unless otherwise defined, all technical and scientific terms used herein have the same meaning as those commonly understood by a person skilled in the art to which the present disclosure belongs. Terms used herein are merely intended to describe objectives of the embodiments of this application, but are not intended to limit this application.

In the embodiments of this application, a term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

In the embodiments of this application, relevant data such as user information is involved. When the embodiments of this application are applied to specific products or technologies, user permission or consent is required, and collection, use, and processing of the relevant data need to comply with relevant laws, regulations, and standards.

Before the embodiments of this application are further described in detail, a description is made on nouns and terms in the embodiments of this application, and the nouns and terms in the embodiments of this application are applicable to the following explanations.
1) The expression “in response to” is configured for representing a condition or status on which one or more to-be-performed operations depend. When the condition or status is met, the one or more operations may be performed immediately or have a set delay. Unless otherwise specified, there is no chronological order between the plurality of to-be-performed operations.
2) Client is an application program running in a terminal to provide various services, such as a video playing client and a game client.
3) Virtual scene is a virtual game scene displayed (or provided) when a game application is run on a terminal. The virtual scene may be a simulated environment of a real world, or may be a semi-simulated semi-fictional virtual environment, or may be an entirely fictional virtual environment. The virtual scene may be any one of a two-dimensional virtual scene, a 2.5-dimensional virtual scene, or a three-dimensional virtual scene, and the dimension of the virtual scene is not limited in the embodiments of this application. For example, the virtual scene may include a sky, a land, an ocean, and the like. The land includes environmental elements such as a desert and a city. A user can control a virtual object to move in the virtual scene.
4) Virtual object represents images of various persons and things for interaction in a virtual scene, or movable objects in the virtual scene. The movable object may be a virtual character, a virtual animal, a cartoon character, or the like, for example, a character or an animal displayed in a virtual scene. The virtual object may be a virtual image configured for representing a user in the virtual scene. The virtual scene may include a plurality of virtual objects, and each virtual object has a shape and a volume in the virtual scene, and occupies a partial space in the virtual scene.

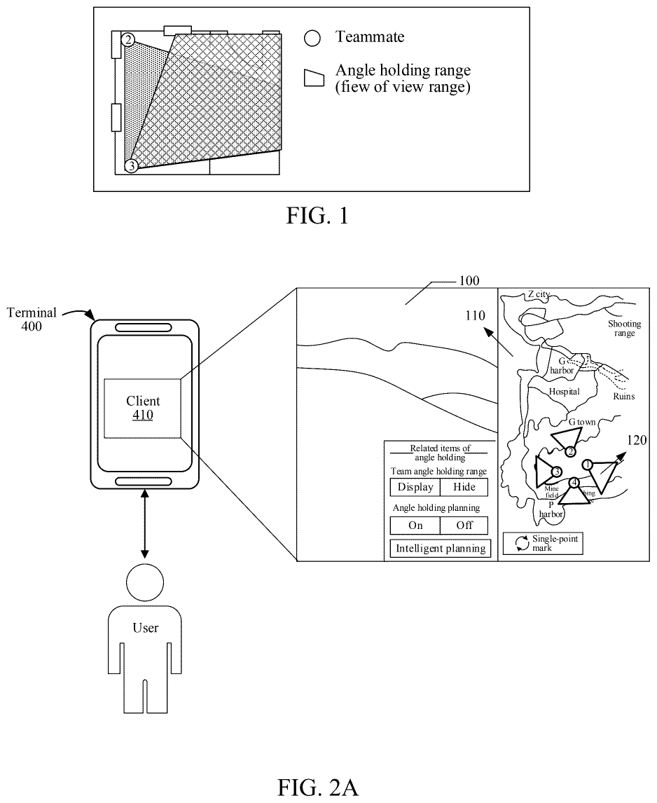

Virtual command object is a virtual object (one player account may control at least one virtual command object) that has a command function in a virtual scene, for example, a boss or a full-time conductor of a social group in a game, and is responsible for coordinating a current attack policy of the social group and target division of labor of a team. Virtual collaboration object is a virtual object (one player account may control at least one virtual collaboration object) that is configured for performing a game task in a virtual scene, for example, an ordinary member in a social group in a game, is responsible for performing a current attack task of the social group and the like.
5) Scene data indicates various features represented by a virtual object in a virtual scene in an interaction process, for example, may include a position of the virtual object in the virtual scene. Certainly, different types of features may be included based on types of virtual scenes. For example, in a virtual scene of a game, the scene data may include waiting time required for various functions configured in the virtual scene (which depends on a usage count of the same function within specific time), and may alternatively represent attribute values of various states of game characters, such as health points (also referred to as a red value) and magic points (also referred to as a blue value).
6) Interaction process is a process obtained through development of a virtual object in a virtual scene based on interaction time or an interaction state, for example, a process in which the virtual object battles in a round of game and a battling process of the virtual object in a scene of a game.
7) Holding an angle (angle holding) refers to a behavior of aiming at a position for observation through a held virtual weapon to pre-aim enemies, after a virtual object controlled by a user (or a player) occupies the position in a game. Angle holding is generally performed within a building of the game, and is performed in a blank outdoor scene in a rare case. As shown in FIG. 1, teammate No. 2 and teammate No. 3 are in a same building. Teammate No. 2 holds an angle in a northwest corner towards a southeast direction, and teammate No. 3 holds an angle in a southwest corner towards a northeast direction.
8) User interface (UI) is an overall design for a human-computer interaction, an operating logic, and a beautiful interface of software. The UI is a medium for interaction and information exchange between a system and a user, and implements conversion between an internal form of information and a form that can be accepted by a human. The UI is related software designed for interaction and communication between a user and hardware, and aims to enable the user to conveniently and efficiently operate the hardware to implement a bidirectional interaction and complete work that is hoped to be completed by using the hardware. The UI is widely defined and includes a human-computer interaction and a graphical user interface. The UI exists in any field participating in human and machinery information exchange.
9) Large map is configured for presenting a complete game world (i.e. a virtual scene), and a player can learn a position of the player and all positions included in the entire game world from the God's perspective.
10) Small map is a map that helps a player to determine a position of a virtual object controlled by the player in a game world and occupies only some display regions on a human-computer interaction interface. The small map presents only a part of the game world of the virtual scene. It is configured for real-time way directing and information feedback, and can help the player to quickly learn the position of the player in the game world and a surrounding geographical environment in a game.

Embodiments of this application provide an interaction processing method and apparatus for a virtual scene, an electronic device, a computer-readable storage medium, and a computer program product, which can improve efficiency of human-computer interactions in the virtual scene. In order to facilitate an easier understanding of an interaction processing method for a virtual scene provided by the embodiments of this application, an exemplary implementation scene of the interaction processing method for the virtual scene provided by the embodiments of this application is first explained. The virtual scene in the interaction processing method for the virtual scene provided by the embodiments of this application can be outputted entirely based on a terminal, or outputted collaboratively based on a terminal and a server.

In some embodiments, the virtual scene may be an environment for interactions of game characters. For example, game characters conduct a battle in the virtual scene. Two parties can interact with each other in the virtual scene by controlling game characters to do actions, so that users can relieve the stress in a game.

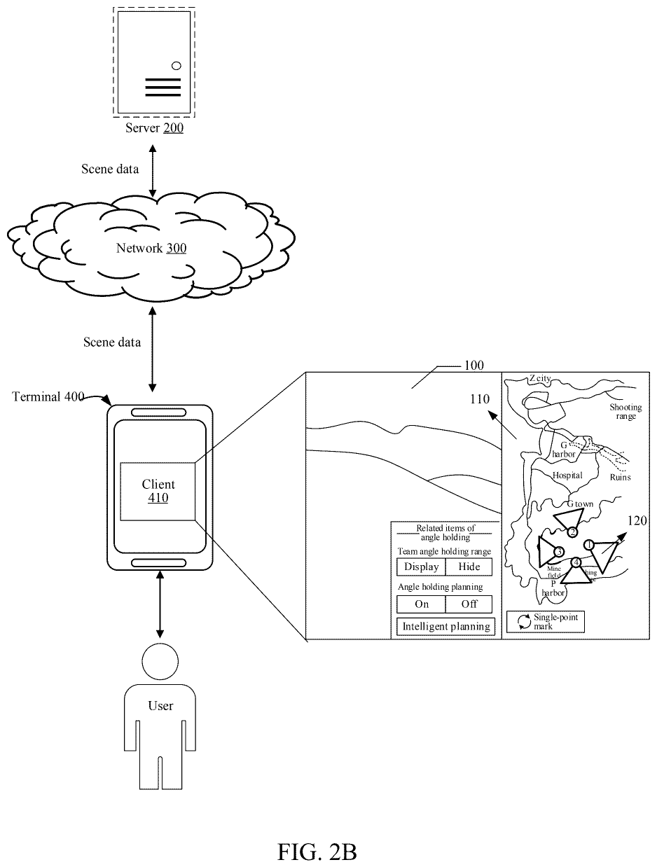

In an implementation scene, FIG. 2A is a schematic diagram showing an application mode of an interaction processing method for a virtual scene according to an embodiment of this application, which is applicable to some application modes in which computation of relevant data of a virtual scene 100 is implemented completely relying on a graphics processing hardware computing capability of a terminal 400, for example, a standalone/offline game completes outputting of the virtual scene through various types of terminals 400 such as a smartphone, a tablet computer, and a virtual reality/augmented reality device, and the like.

For example, the graphics processing hardware includes a central processing unit (CPU) and a graphics processing unit (GPU).

To form a visual perception of the virtual scene 100, the terminal 400 computes data required for displaying through graphics computing hardware, and completes loading, parsing, and rendering of display data. Graphics output hardware outputs video frames that can form the visual perception of the virtual scene, for example, two-dimensional video frames are displayed on a display screen of a smartphone, or, video frames that achieve a three-dimensional display effect are projected to lenses of augmented reality/virtual reality glasses. In addition, to enrich a perception effect, the terminal 400 may further form one or more of auditory perception, tactile perception, motion perception, and taste perception through different hardware.

For example, the terminal 400 runs a client 410 (for example, a standalone game application), and outputs a virtual scene including role play during the running of the client 410. The virtual scene may be an environment for game characters to interact, for example, may be a plain, a street, a valley, and the like for game characters to battle. An example in which the virtual scene 100 is displayed in a first-person perspective is used. A plurality of virtual objects are displayed in the virtual scene 100. In response to a displaying trigger operation for a map of a virtual scene, the map 110 is displayed in the virtual scene. The displaying trigger operation for the map is also referred to as a “map displaying trigger operation.” In response to an interaction condition being satisfied, an interaction range 120 of a target virtual object is displayed on the map 110, or in response to the interaction condition being satisfied, the interaction range of the target virtual object is displayed in the virtual scene. The target virtual object is at least one of the plurality of virtual objects, and the interaction range is a range within which a virtual weapon held by the target virtual object can attack. The plurality of virtual objects may be game characters controlled by users (or players). To be specific, the virtual objects are controlled by the real users and will operate in the virtual scene in response to operations performed by the real users on buttons (including a joystick button, an attack button, a defense button, and the like). For example, when the real user moves the joystick button to the left, the virtual object will move to the left in the virtual scene, and can also stand still, jump, and use various functions (such as skills and props).

In another implementation scene, FIG. 2B is a schematic diagram showing an application mode of an interaction processing method for a virtual scene according to an embodiment of this application. The method is applied to a terminal 400 and a server 200, and is applicable to an application mode in which computation of a virtual scene is completed relying on a computing capability of the server 200 and the virtual scene is outputted at the terminal 400.

An example in which a visual perception of the virtual scene 100 is formed is used. The server 200 computes display data (such as scene data) related to a virtual scene and transmits the display data to the terminal 400 through a network 300. The terminal 400 loads, parses, and renders the computed display data by using graphics computation hardware, and outputs the virtual scene by using graphics outputting hardware, so as to form the visual perception, for example, two-dimensional video frames can be displayed on a display screen of a smartphone, or video frames that achieve a three-dimensional display effect are projected to lenses of augmented reality/virtual reality glasses. For perception in the form of the virtual scene, the virtual scene may be outputted through corresponding hardware of the terminal 400, for example, auditory perception is formed by using a microphone, tactile perception is formed by using a vibrator, and the like.

For example, the terminal 400 runs a client 410 (for example, an online game application) and implements game interactions with other users by being connected to the server 200 (for example, a game server). The terminal 400 outputs a virtual scene 100 of the client 410. An example in which the virtual scene 100 is displayed in a first-person perspective is used. A plurality of virtual objects are displayed in the virtual scene 100. In response to a displaying trigger operation for a map of a virtual scene, the map 110 is displayed in the virtual scene. In response to an interaction condition being satisfied, an interaction range 120 of a target virtual object is displayed on the map 110, or in response to the interaction condition being satisfied, the interaction range of the target virtual object is displayed in the virtual scene. The target virtual object is at least one of the plurality of virtual objects, and the interaction range is a range within which a virtual weapon held by the target virtual object can attack. The plurality of virtual objects may be game characters controlled by users (or players). To be specific, the virtual objects are controlled by the real users and will operate in the virtual scene in response to operations performed by the real users on buttons (including a joystick button, an attack button, a defense button, and the like). For example, when the real user moves the joystick button to the left, the virtual object will move to the left in the virtual scene, and can also stand still, jump, and use various functions (such as skills and props).

In some embodiments, the terminal 400 may further implement an interaction processing method for a virtual scene provided in the embodiments of this application by running a computer program. For example, the computer program may be a native program or software module in an operating system; a native application (APP), namely, an application that needs to be installed in the operating system for running, for example, a battle game APP (i.e. the above client 410); a mini program, namely, a program that can be run simply by being downloaded into a browser environment; or a game mini program that can be embedded into any APP. In conclusion, the above computer program can be any form of APP, module, or plug-in.

An example in which the computer program is an APP is used. In actual implementation, the terminal 400 installs and runs an APP that supports a virtual scene. This APP may be any one of first-person shooting game (FPS), a third-person shooting game, a virtual reality APP, a three-dimensional map program, or a multi-person gunfight survival game. A user uses the terminal 400 to operate a virtual object in the virtual scene to do activities. The activities include, but are not limited to, at least one of adjusting the posture of the body, crawling, walking, running, riding, jumping, driving, picking up, shooting, attacking, throwing, or constructing a virtual building. Exemplarily, the virtual object may be a virtual character, such as a simulated character or an animation character.

In some embodiments, the server 200 in FIG. 2B may be an independent physical server, or may be a server cluster or a distributed system formed by a plurality of physical servers, or may be a server that provides basic cloud computing services such as cloud services, cloud databases, cloud computing, cloud functions, cloud storage, network services, cloud communication, middleware services, domain name services, security services, content delivery networks (CDNs), big data, and artificial intelligence platforms. The terminal 400 may be a smartphone, a tablet computer, a notebook computer, a desktop computer, a smart speaker, a smart watch, or the like, but is not limited thereto. The terminal 400 and the server 200 may be directly or indirectly joined through wired or wireless communication. This is not limited in this embodiment of this application.

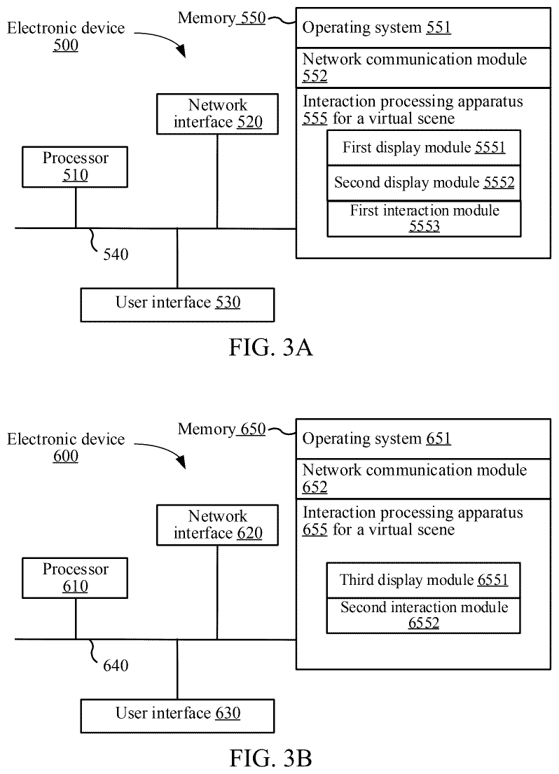

The following describes a structure of an electronic device for interaction processing provided in the embodiments of this application. FIG. 3A is a schematic structural diagram of an electronic device 500 for interaction processing according to an embodiment of this application. An example in which the electronic device 500 is a terminal 400 is used for description. The electronic device 500 for interaction processing shown in FIG. 3A includes: at least one processor 510, a memory 550, at least one network interface 520, and a user interface 530. The components in the electronic device 500 are coupled together by using a bus system 540. The bus system 540 is configured to implement connection and communication between the components. In addition to a data bus, the bus system 540 further includes a power bus, a control bus, and a state signal bus. However, for clear description, various buses in FIG. 3A are together referred to as the bus system 540.

The processor 510 may be an integrated circuit chip having a signal processing capability, for example, a general purpose processor, a digital signal processor (DSP), another programmable logic device, discrete gate or transistor logic device, or discrete hardware component, or the like. The general purpose processor may be a microprocessor or any conventional processor, or the like.

The memory 550 includes a volatile memory or a non-volatile memory, or may include both a volatile memory and a non-volatile memory. The non-volatile memory may be a read only memory (ROM). The volatile memory may be a random access memory (RAM). The memory 550 described in this embodiment of this application is to include any other suitable types of memories. The memory 550 alternatively includes one or more storage devices away from the processor 510 in physical positions.

In some embodiments, the memory 550 may store data to support various operations. Examples of the data include a program, a module, and a data structure or other subsets or supersets, which are exemplified below.

An operating system 551 includes system programs for processing various basic system services and performing hardware-related tasks, such as a framework layer, a kernel library layer, and a drive layer, and is configured to implement various basic services and process hardware-based tasks.

A network communication module 552 is configured to reach another computing device through one or more (wired or wireless) network interfaces 520. Exemplary network interfaces 520 include: Bluetooth, wireless compatible authentication (WiFi), a universal serial bus (USB), and the like.

In some embodiments, an interaction processing apparatus according to the embodiments of this application may be implemented in a software manner. The interaction processing apparatus according to the embodiments of this application may be provided in various software embodiments, including various forms such as an application program, software, a software module, a script, or a code.

FIG. 3A shows an interaction processing apparatus 555 for a virtual scene, which is stored in the memory 550. The apparatus 555 may be software in a form of a program and a plug-in, and include a series of modules: a first display module 5551, a second display module 5552, and a first interaction module 5553. These modules are logical and may be arbitrarily combined or further split depending on functions implemented. Functions of the modules will be described below.

FIG. 3B is a schematic structural diagram of an electronic device 600 according to an embodiment of this application. An example in which the electronic device 600 is a terminal 400 is used for description. The electronic device 600 shown in FIG. 3B includes: at least one processor 610, a memory 650, at least one network interface 620, and a user interface 630. The components in the electronic device 600 are coupled together by using a bus system 640. The memory 650 includes an operating system 651 and a network communications module 652. A function of the structure in FIG. 3B is similar to the function of the structure in FIG. 3A. An interaction processing apparatus for a virtual scene provided in this embodiment of this application may be implemented by software. FIG. 3B shows an interaction processing apparatus for a virtual scene 655 stored in the memory 650, which may be software in a form of a program and a plug-in, and includes the following software modules: a third display module 6551 and a second interaction module 6552. The modules are logical and may be arbitrarily combined or further split depending on functions implemented.

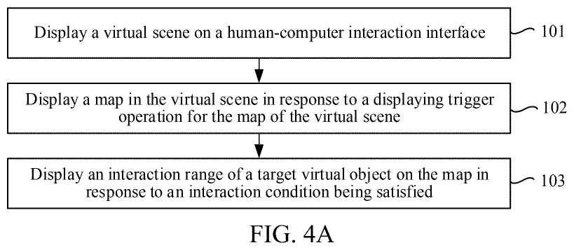

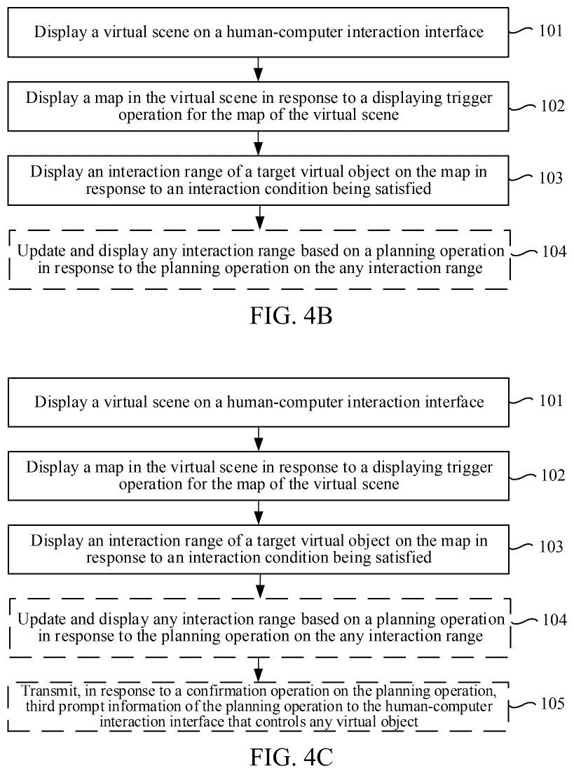

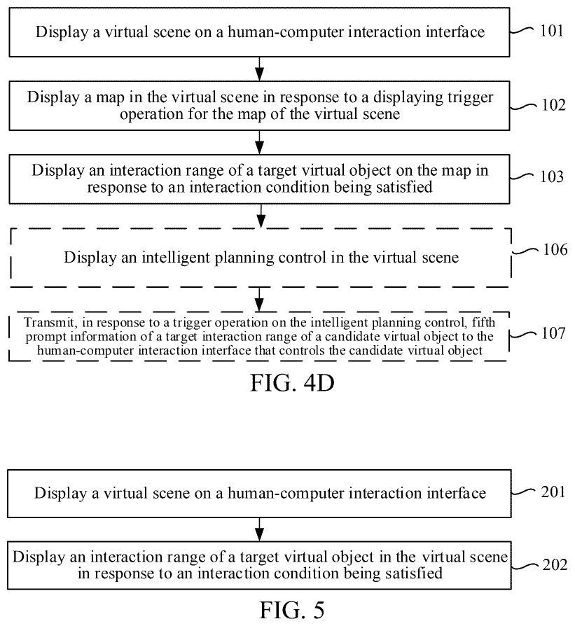

As described above, the interaction processing method for the virtual scene provided in this embodiment of this application may be implemented by various types of electronic devices, for example, a terminal, a server, or a combination of a terminal and a server. Therefore, an executing entity of operations is not repeatedly described below. FIG. 4A is a schematic flowchart of an interaction processing method for a virtual scene according to an embodiment of this application. The method is described with reference to operations shown in FIG. 4A.

The method shown in FIG. 4A may be performed by computer programs in various forms, which are run on a terminal 400 and are not limited to the above client 410. Or, the computer programs may be the above operating system 461, the above software module, and the above script. Therefore, the client is not considered as limiting the embodiments of this application.

In operation 101, the virtual scene is displayed on a human-computer interaction interface, the virtual scene including a plurality of virtual objects.

The plurality of (i.e. at least two) virtual objects may belong to at least one virtual faction. For example, the plurality of virtual objects belong to one virtual faction. To be specific, the plurality of virtual objects are configured for cooperatively completing a game task. The plurality of virtual objects may belong to a plurality of virtual factions. For example, each virtual object may belong to a different virtual faction, and the different virtual factions fight against each other. For example, some of the plurality of virtual objects are in a same virtual faction, and other virtual objects among the plurality of virtual objects are in another virtual faction. The two virtual factions fight against each other.

In operation 102, a map is displayed in the virtual scene in response to a displaying trigger operation for the map of the virtual scene.

For example, when game guidance needs to be performed based on the map, displaying of the map of the virtual scene may be triggered, to display the map in the virtual scene. The map here may be a large map of the virtual scene, or may be a small map of the virtual scene. A form of the displaying trigger operation is not limited in this embodiment of this application, and may be a form of click/tap, double click/tap, long press, or the like.

In this embodiment of this application, the map is displayed in the virtual scene only in response to the displaying trigger operation, thus avoiding displaying a small map in the virtual scene all the time. Compared with a solution in the related art in which a small map is always displayed, this embodiment of this application can avoid a problem that the map occupies a display space, thereby simplifying information displaying in the virtual scene and increasing a utilization rate of a display resource.

In operation 103, an interaction range of a target virtual object is displayed on the map in response to an interaction condition being satisfied, the target virtual object being at least one of the plurality of virtual objects, and the interaction range being a range within which a virtual weapon held by the target virtual object is able to attack.

Herein, the interaction range may be an attack range within a field of view range of the virtual weapon, or the interaction range may include an attack range beyond the field of view range. For example, when the virtual weapon is a virtual gun, the interaction range is an attack range, for example, an angle holding range, within a field of view when the virtual object holds the virtual weapon for aiming. When the virtual weapon is a virtual cannonball, the interaction range is an attack range when the virtual object holds the virtual weapon and throws it, and the attack range may be beyond a field of view range of the virtual object. A shape of the interaction range is not limited in this embodiment of this application. For example, the interaction range may be a sector, a triangle, or the like.

In some embodiments, the interaction condition may be that a displaying trigger operation for the interaction range (also referred to as a “range displaying trigger operation”) is received.

A form of the displaying trigger operation is not limited in this embodiment of this application, and may be a form of click/tap, double click/tap, or the like.

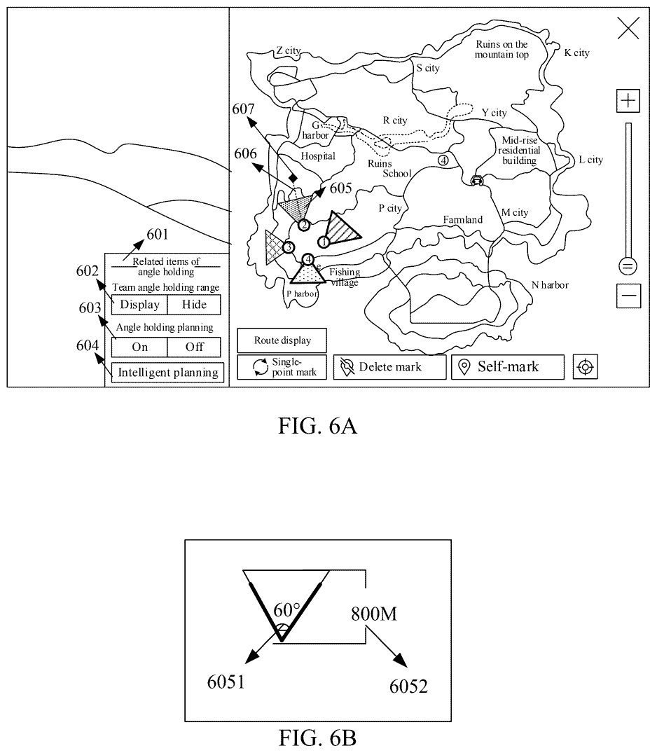

As an example of the displaying trigger operation, before the interaction range of the target virtual object is displayed on the map, an interaction range trigger control is displayed in the virtual scene, and a trigger operation on the interaction range trigger control is determined as the displaying trigger operation. As shown in FIG. 6A, when a player opens a map in a game, a “team angle holding range” switch 602 (i.e. the interaction range trigger control) is displayed in a virtual scene. The “team angle holding range” switch 602 is off by default, which is an initial state, and a trigger operation on the “team angle holding range” switch 602 is determined as the displaying trigger operation.

In an example of the displaying trigger operation, before the interaction range of the target virtual object is displayed on the map, first prompt information displayed for the interaction range is displayed in the virtual scene, and a confirmation operation on the first prompt information is determined as the displaying trigger operation.

In this way, after the displaying trigger operation for the interaction range is received, this embodiment of this application displays the interaction range of the target virtual object on the map, to indicate the range within which the virtual weapon held by the target virtual object can attack, so that the interaction range of the target virtual object can be efficiently known through a manual operation, and effective cooperation of the virtual objects can be implemented. Compared with the related art that requires additional communication resources and computing resources for communication, related communication resources and computing resources are saved, efficiency of human-computer interaction in the virtual scene is improved, and a utilization rate of a display resource is increased.

In some embodiments, the interaction condition may be one of the following: a quantity of virtual objects that launch an attack with the virtual weapon in the virtual scene reaches a first quantity threshold. Each virtual object that launches an attack with the virtual weapon is an alliance virtual object or an opposing virtual object. The alliance virtual object is a virtual object that is in a same virtual faction as a first virtual object. The opposing virtual object is a virtual object that is in an opposing virtual faction of the first virtual object. The first virtual object is a controlled virtual object on the human-computer interaction interface.

In this way, when the quantity of virtual objects that launch an attack with the virtual weapon in the virtual scene reaches the first quantity threshold, it indicates that the interaction range needs to be viewed in this case, to perform proper planning to complete a game task. Thus, the interaction range of the target virtual object is automatically displayed, to indicate the range within which the virtual weapon held by the target virtual object can attack, so that effective cooperation of the virtual objects can be implemented. Compared with the related art that requires additional communication resources and computing resources for communication, related communication resources and computing resources are saved, efficiency of human-computer interaction in the virtual scene is improved, and a utilization rate of a display resource is increased.

In some embodiments, the interaction condition may be that the virtual object that is in the same virtual faction as the first virtual object is under attack. The first virtual object is the controlled virtual object on the human-computer interaction interface. When the virtual object located in the same virtual faction as the first virtual object is under attack, it indicates that the interaction range needs to be displayed, so as to perform proper planning and implement a counterattack. Thus, the interaction range of the target virtual object is automatically displayed, to indicate the range within which the virtual weapon held by the target virtual object can attack, so that effective cooperation of the virtual objects can be implemented.

In some embodiments, the interaction condition may be that a number of times that an account controlling the first virtual object performs the displaying trigger operation reaches a first number-of-times threshold. When the number of times that the account controlling the first virtual object performs the displaying trigger operation reaches the first number-of-times threshold, it indicates that the account controlling the first virtual object is accustomed to viewing the interaction range. Therefore, the interaction range can be automatically displayed, so that the account controlling the first virtual object can view the interaction range.

In some embodiments, the interaction condition may be that a prediction instruction that is returned by a neural network model and is for displaying the interaction range is received. The prediction instruction is obtained by the neural network model performing the following processing: calling the neural network model for prediction based on an account feature of the account controlling the first virtual object and scene data of the virtual scene, to obtain the prediction instruction for displaying the interaction range. The neural network model is obtained by training an account feature sample of an account sample, a scene data sample, and a prediction instruction annotation.

A model structure of the neural network model is not limited in this embodiment of this application. For example, the neural network model may be a convolutional neural network, a deep neural network, or the like.

Before the neural network model is applied, an initial neural network model needs to be trained, and then the trained neural network model is put into application. Whether the interaction range needs to be displayed is predicted through an artificial intelligence technology with reference to a habit of a player and a current game scene. The neural network model is obtained by training the account feature sample of the account sample, the scene data sample, and the prediction instruction annotation. For example, the initial neural network model is called for prediction based on the account feature sample of the account sample and the scene data sample, to obtain the prediction instruction (for example, if the prediction instruction is 1, it indicates that the interaction range needs to be displayed; if the prediction instruction is 0, the interaction range does not need to be displayed). After a value of a loss function of the neural network model is determined based on the prediction instruction and the prediction instruction annotation, whether the value of the loss function exceeds a preset threshold may be determined. When the value of the loss function exceeds the preset threshold, an error signal of the neural network model is determined based on the loss function. The error signal is back-propagated in the neural network model, and model parameter of layers are updated in the propagation process. A form of the loss function is not limited in this embodiment of this application. For example, the loss function may be a cross entropy loss function, an L2 loss function, or the like.

The back-propagation is described herein. Training sample data is inputted to an input layer of the neural network model. The data passes through a hidden layer and finally reaches an output layer, and a result is outputted. This is a forward-propagation process of the neural network model. Since there is an error between an outputted result of the neural network model and an actual result, an error between the outputted result and an actual value is calculated, and the error is back-propagated from the output layer to the hidden layer until the error is propagated to the input layer. In the back-propagation process, a value of the model parameter is adjusted based on the error. That is, the loss function is constructed according to the error between the outputted result and the actual value, and partial derivatives of the loss function for the model parameter are calculated layer by layer, to generate a gradient of the loss function for the model parameter of each layer. Since a direction of the gradient indicates an error expansion direction, the gradient for the model parameter is negated for summation with an original model parameter of each layer. An obtained summation result is used as an updated model parameter of each layer, thus reducing the error caused by the model parameter. The above process is continuously iterated until convergence occurs.

In some embodiments, the interaction range includes an attack angle range that uses a current orientation of the target virtual object as a center line and an attack distance in the attack angle range; and the attack angle range is an angle range within which the virtual weapon held by the target virtual object can attack.

For example, when the interaction range is an angle holding range. As shown in FIG. 6B, the angle holding range includes a field of view angle range 6051 (i.e. the attack angle range) that uses the current orientation of the target virtual object as the center line and a field of view distance 6052 (i.e. the attack distance) in the field of view angle range. The angle holding range is a triangular region in which a virtual object controlled by a player is a vertex of an equilateral triangle (the field of view angle range 6051 is 60°) and a height (i.e. the field of view distance 6052) is 800 m. Certainly, the field of view angle range 6051 and the field of view distance 6052 may be adjusted based on a scale of a large map of each game. The field of view angle range 6051 and the field of view distance 6052 are not limited in this embodiment of this application.

In some embodiments, the target virtual object is the virtual object that is in the same virtual faction as the first virtual object, and the first virtual object is the controlled virtual object on the human-computer interaction interface. In operation 103, that “an interaction range of a target virtual object on the map is displayed” may be implemented in the following manner: displaying an identifier of the target virtual object on the map, and displaying interaction ranges corresponding to different identifiers based on different first display parameters, the first display parameters including at least one of the following: a color, a size, a shape, and an effect.

As shown in FIG. 6A, an angle holding range 605 in a corresponding color is displayed on the map based on a color of a serial number (i.e. the identifier) of a teammate (i.e. the virtual object that is in the same virtual faction as the first virtual object).

In some embodiments, the target virtual object includes an alliance virtual object and an opposing virtual object. The alliance virtual object is the virtual object that is in the same virtual faction as the first virtual object, and the opposing virtual object is the virtual object that is in the opposing virtual faction of the first virtual object. The first virtual object is the controlled virtual object on the human-computer interaction interface. In operation 103, that “an interaction range of a target virtual object on the map is displayed” may be implemented in the following manner: displaying an interaction range of the opposing virtual object on the map based on a second display parameter, the second display parameter being distinguished from a display parameter used by an interaction range of the alliance virtual object, and the second display parameter including at least one of the following: a color, a size, a shape, and an effect.

In this way, by differently displaying the interaction range of the alliance virtual object and the interaction range of the opposing virtual objects, a player can view the interaction ranges and efficiently learn about the interaction ranges of the virtual objects of different virtual factions, thereby implementing effective cooperation of the virtual objects. Compared with the related art that requires additional communication resources and computing resources for communication, related communication resources and computing resources are saved, efficiency of human-computer interaction in the virtual scene is improved, and a utilization rate of a display resource is increased.

In some embodiments, before the interaction range of the target virtual object is displayed on the map, a plurality of candidate types of virtual objects on which interaction ranges are to be displayed are displayed in the virtual scene; and a virtual object of a selected candidate type is used as the target virtual object in response to a selection operation on the candidate types. The plurality of candidate types may include teammate, enemy, a customized type, and the like. A form of the selection operation is not limited in this embodiment of this application, and may be, for example, a form of click/tap, double click/tap, slide, or the like.

In this way, by selecting a candidate type, this embodiment of this application can implement manual selection of an interaction range needing to be displayed, so that a player can view the interaction range corresponding to the selected candidate type and efficiently learn about the interaction ranges of the virtual objects, thereby implementing effective cooperation of the virtual objects. Compared with the related art that requires additional communication resources and computing resources for communication, related communication resources and computing resources are saved, efficiency of human-computer interaction in the virtual scene is improved, and a utilization rate of a display resource is increased.

In some embodiments, after the interaction range of the target virtual object is displayed on the map, in response to any virtual object holding the virtual weapon among the target virtual object to complete the attack, an attack trajectory of the virtual weapon held by the any virtual object is displayed within the interaction range of the any virtual object; and a mark of a target is displayed on the map in response to the virtual weapon held by the any virtual object hitting the target.

For example, when the virtual weapon is a virtual gun, the attack trajectory is a gun line trajectory. The target may be any virtual object in the virtual scene or may be a virtual object in the virtual scene. As shown in FIG. 6A, the angle holding range 605 (i.e. an interaction range) in the corresponding color is displayed in a large map based on the color of the serial number of the teammate. When a virtual object controlled by a player fires a gun, a gray ant line 606 is displayed on the large map to express the gun line trajectory of the virtual weapon. If the virtual weapon hits an enemy (i.e. the target), point marking 607 is automatically performed on the enemy.

In this way, in this embodiment of this application, after the interaction range of the target virtual object is displayed on the map, the attack trajectory of the virtual weapon is displayed. After the virtual weapon hits the target, the mark of the target is displayed, thus assisting in viewing the attack trajectory and the hit target through the interaction range, to facilitate the effective cooperation between the virtual objects, improve efficiency of human-computer interaction in the virtual scene, and increase a utilization rate of a display resource.

FIG. 4B is a schematic flowchart of an interaction processing method for a virtual scene according to an embodiment of this application. FIG. 4B shows that after operation 103 in FIG. 4A, operation 104 is further performed. In operation 104, any interaction range is updated and displayed based on a planning operation in response to the planning operation on the any interaction range, the any interaction range being the interaction range of any virtual object among the target virtual object.

Herein, the first virtual object is used as a planner who manually plans the interaction range displayed on the map, to implement a manual planning function. A form of the planning operation is not limited in this embodiment of this application, and may be, for example, a form of click/tap, double click/tap, slide, or the like.

In some embodiments, that any interaction range is updated and displayed based on a planning operation in response to the planning operation on the any interaction range may be implemented in the following manner: displaying an interaction planning control in the virtual scene; displaying second prompt information of the interaction range of the target virtual object in response to a trigger operation on the interaction planning control, the second prompt information being configured for indicating that the interaction range is in a plannable state; and controlling, in response to a moving operation on the any interaction range in the plannable state, the any interaction range to move.

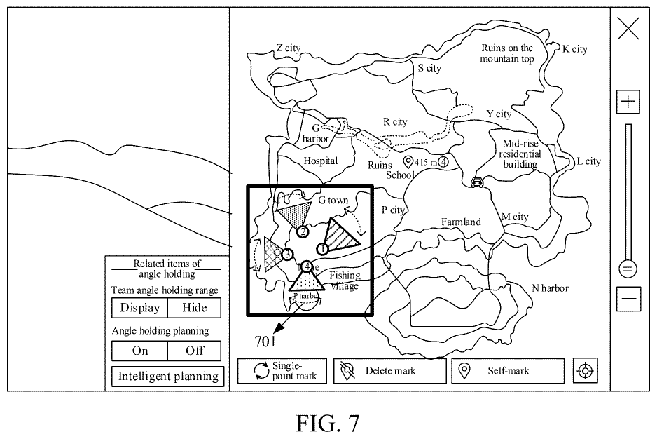

As shown in FIG. 7, an “angle holding planning” switch (i.e. the interaction planning control) is displayed in the virtual scene. In this case, the “angle holding planning” switch is off by default. In response to a trigger operation on the “angle holding planning” switch, the “angle holding planning” switch is turned on, and an ant line 701 with double arrows (i.e. the second prompt information) is displayed within the interaction range displayed on the map, to notify a player that the interaction range can be moved. To be specific, the interaction range is in the plannable state. Certainly, the second prompt information may alternatively be prompt text, for example, text of “plannable interaction range.”

In some embodiments, that any interaction range is updated and displayed based on a planning operation in response to the planning operation on the any interaction range may be implemented in the following manner: controlling, in response to a moving operation on the any interaction range, the any interaction range to move.

FIG. 4C is a schematic flowchart of an interaction processing method for a virtual scene according to an embodiment of this application. FIG. 4C shows that after operation 104 in FIG. 4B, operation 105 is further performed. In operation 105, third prompt information of the planning operation is transmitted, in response to a confirmation operation on the planning operation, to the human-computer interaction interface that controls any virtual object, the third prompt information being configured for instructing to update any interaction range to an interaction range corresponding to the planning operation by controlling the any virtual object to move in the virtual scene. A form of the confirmation operation is not limited in this embodiment of this application, and may be, for example, a form of click/tap, double click/tap, slide, or the like.

In this way, in this embodiment of this application, whether to perform the planning operation is determined for the second time through the confirmation operation, thereby avoiding a misoperation and improving accuracy of the planning operation.

In some embodiments, operation 105 may be implemented in the following manner: displaying fourth prompt information on the map in response to the planning operation being completed, the fourth prompt information being configured for instructing to confirm the planning operation; and transmitting, in response to a confirmation operation on the fourth prompt information, the third prompt information of the planning operation to the human-computer interaction interface that controls any virtual object.

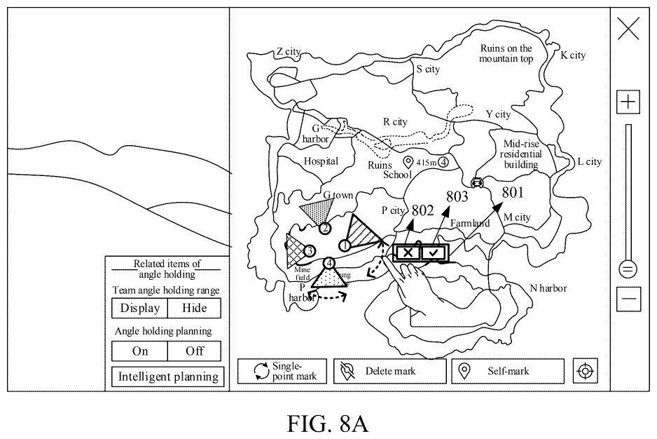

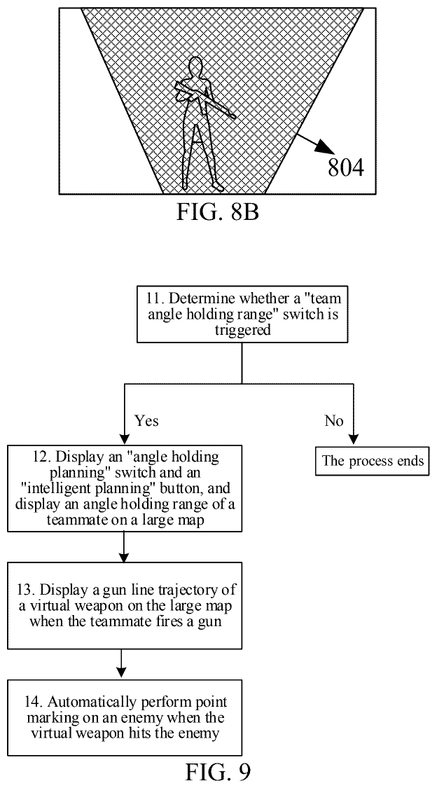

As shown in FIG. 8A, in response to the interaction range of any virtual object on the large map being moved, the interaction range of the any virtual object becomes luminous yellow for prompting. Meanwhile, circular rotation is performed by using a current position of the any virtual object as a circle center. A rotation angle is kept consistent with a movement angle of the player. When a moving gesture is released (i.e. the planning operation is completed), prompt information 801 (i.e. the fourth prompt information) appears beside the moved interaction range. If a “×” cancel control 802 in the prompt information 801 is clicked/tapped, the planning operation is canceled. If a “√” confirm control 803 in the prompt information 801 is clicked/tapped, prompt information (i.e. a planning prompt) of the planning operation is transmitted to the human-computer interaction interface that controls any virtual object.

FIG. 4D is a schematic flowchart of an interaction processing method for a virtual scene according to an embodiment of this application. FIG. 4D shows that FIG. 4A further includes operation 106 and operation 107.

In operation 106, an intelligent planning control is displayed in the virtual scene.

The intelligent planning control is configured for automatically planning an interaction range when triggered, to implement a function of intelligently planning an interaction range.

In some embodiments, operation 106 may be implemented in the following manner: displaying, in the virtual scene in response to the target virtual object on the map being not planned, an intelligent planning control that is in a triggerable state; and displaying, in the virtual scene in response to the target virtual object on the map being planned, an intelligent planning control that is in a non-triggerable state, a display parameter of the intelligent planning control that is in the triggerable state being different from a display parameter of the intelligent planning control that is in the non-triggerable state.

When the intelligent planning control is in the triggerable state, it indicates that the intelligent planning control can be triggered, and implements, after being triggered, the function of automatically planning an interaction range. When the intelligent planning control is in the non-triggerable state, it indicates that the intelligent planning control cannot be triggered, and cannot implement the function of automatically planning an interaction range.

For example, when there is no planning operation in the virtual scene (namely, the target virtual object on the map is not planned), an “intelligent planning” button (i.e. the intelligent planning control) is highlighted (namely, the intelligent planning control is in the triggerable state). When there is the planning operation in the virtual scene (namely, the target virtual object on the map is planned), the “intelligent planning” button is displayed in gray (namely, the intelligent planning control is in the non-triggerable state).

In this way, in this embodiment of this application, the intelligent planning control that is in the triggerable state and the intelligent planning control that is in the non-triggerable state are displayed in different cases, to remind a player or a user whether the function of automatically planning an interaction range by one click/tap can be implemented currently.

In some embodiments, when the intelligent planning control is in the non-triggerable state, sixth prompt information is displayed in the virtual scene in response to a trigger operation on the intelligent planning control, the sixth prompt information being configured for indicating that the target virtual object on the map is being planned.

Continuing the foregoing example, when the “intelligent planning” button is displayed in gray (namely, the intelligent planning control is in the non-triggerable state), and does not work after the player clicks/taps the button, a system prompt (i.e. the sixth prompt information) pops up to prompt the player that the target virtual object on the map is being planned, and the intelligent planning function cannot be used.

In operation 107, fifth prompt information of a target interaction range of a candidate virtual object is transmitted, in response to a trigger operation on the intelligent planning control, to the human-computer interaction interface that controls the candidate virtual object, the candidate virtual object being at least one virtual object among the target virtual object, the target interaction range being an automatically determined new interaction range of the candidate virtual object, an area covered by the target interaction range of the candidate virtual object being larger than an area covered by the interaction range of the candidate virtual object, and the fifth prompt information being configured for instructing to update the interaction range of the candidate virtual object to the target interaction range by controlling the candidate virtual object to move in the virtual scene.

In some embodiments, when there are a plurality of candidate virtual objects, before the fifth prompt information of the target interaction range of the candidate virtual object is transmitted to the human-computer interaction interface that controls the candidate virtual object, a first interaction range and a second interaction range of each candidate virtual object are determined, the first interaction range being an interaction range having a largest coverage area, and the second interaction range being an interaction range having a second largest coverage area. In response to overlapping existing between the first interaction ranges of any two candidate virtual objects, the second interaction range of a first candidate virtual object is used as the target interaction range of the first candidate virtual object, and using the first interaction range of a second candidate virtual object as the target interaction range of the second candidate virtual object, the first candidate virtual object being a candidate virtual object with the largest second interaction range in the any two candidate virtual objects, and the second candidate virtual object being the other candidate virtual object in the any two candidate virtual objects except the first candidate virtual object; and the first interaction ranges of the any two candidate virtual objects is used as the target interaction ranges of the any two candidate virtual objects in response to no overlapping existing between the first interaction ranges of the any two candidate virtual objects.

Since an angle holding range of a virtual object in some orientations may be blocked, areas covered by the angle holding range of the virtual object in different orientations are different. The candidate virtual object is at least one of the following: a virtual object selected from the target virtual object through a selection operation; a virtual object, which is configured for assisting in launching an attack, among the target virtual object; and a virtual object for which a number of planned operations exceeds a second number-of-times threshold.

As described above, the interaction processing method for the virtual scene provided in this embodiment of this application may be implemented by various types of electronic devices, for example, a terminal, a server, or a combination of a terminal and a server. Therefore, an executing entity of operations is not repeatedly described below. FIG. 5 is a schematic flowchart of an interaction processing method for a virtual scene according to an embodiment of this application. The method is described with reference to operations shown in FIG. 5.

In operation 201, the virtual scene is displayed on a human-computer interaction interface, the virtual scene including a plurality of virtual objects.

The plurality of (i.e. at least two) virtual objects may belong to at least one virtual faction.

In operation 202, an interaction range of a target virtual object is displayed in the virtual scene in response to an interaction condition being satisfied, the target virtual object being at least one of the plurality of virtual objects, and the interaction range being a range within which a virtual weapon held by the target virtual object is able to attack.

Operation 202 is similar to operation 103. Details are not elaborated here.

In some embodiments, the interaction condition includes one of the following: the displaying trigger operation for the interaction range is received; a quantity of virtual objects that launch an attack with the virtual weapon in the virtual scene reaches a first quantity threshold; a virtual object that is in a same virtual faction as a first virtual object is under attack, the first virtual object being a controlled virtual object on the human-computer interaction interface; a number of times that an account controlling the first virtual object performs the displaying trigger operation reaches a first number-of-times threshold; and a prediction instruction that is returned by a neural network model and is for displaying the interaction range is received.

In some embodiments, the prediction instruction is obtained by the neural network model performing the following processing: calling the neural network model for prediction based on an account feature of the account controlling the first virtual object and scene data of the virtual scene, to obtain the prediction instruction for displaying the interaction range. The neural network model is obtained by training an account feature sample of an account sample, a scene data sample, and a prediction instruction annotation.

In some embodiments, an interaction range trigger control is displayed in the virtual scene, and a trigger operation on the interaction range trigger control is determined as the displaying trigger operation; and/or, first prompt information for the displaying of the interaction range is displayed in the virtual scene, and a confirmation operation on the first prompt information is determined as the displaying trigger operation.

In some embodiments, the interaction range includes an attack angle range that uses a current orientation of the target virtual object as a center line and an attack distance in the attack angle range; and the attack angle range is an angle range within which the virtual weapon held by the target virtual object can attack.

In some embodiments, the target virtual object is the virtual object that is in the same virtual faction as the first virtual object, and the first virtual object is a controlled virtual object on the human-computer interaction interface. That an interaction range of a target virtual object in the virtual scene may be implemented in the following manner: displaying an identifier of the target virtual object in the virtual scene, and displaying interaction ranges corresponding to different identifiers based on different first display parameters, the first display parameters including at least one of the following: a color, a size, a shape, and an effect.

In some embodiments, the target virtual object includes an alliance virtual object and an opposing virtual object. The alliance virtual object is the virtual object that is in the same virtual faction as the first virtual object. The opposing virtual object is a virtual object that is in an opposing virtual faction of the first virtual object; the first virtual object is the controlled virtual object on the human-computer interaction interface. That an interaction range of a target virtual object is displayed in the virtual scene may be implemented in the following manner: displaying an interaction range of the opposing virtual object in the virtual scene based on a second display parameter, the second display parameter being distinguished from a display parameter used by an interaction range of the alliance virtual object, and the second display parameter including at least one of the following: a color, a size, a shape, and an effect.

In some embodiments, before the interaction range of the target virtual object is displayed in the virtual scene, a plurality of candidate types of virtual objects on which interaction ranges are to be displayed are displayed in the virtual scene; and a virtual object of a selected candidate type is used as the target virtual object in response to a selection operation on the candidate types.

In some embodiments, after the interaction range of the target virtual object is displayed in the virtual scene, in response to any virtual object holding the virtual weapon among the target virtual object to complete the attack, an attack trajectory of the virtual weapon held by the any virtual object is displayed within the interaction range of the any virtual object; and a mark of a target is displayed in the virtual scene in response to the virtual weapon held by the any virtual object hitting the target.

In some embodiments, after an interaction range of a target virtual object is displayed in the virtual scene, any interaction range is updated and displayed based on a planning operation in response to the planning operation on the any interaction range, the any interaction range being the interaction range of any virtual object among the target virtual object.

In some embodiments, that any interaction range is updated and displayed based on a planning operation in response to the planning operation on the any interaction range may be implemented in the following manner: displaying an interaction planning control in the virtual scene; displaying second prompt information of the interaction range of the target virtual object in response to a trigger operation on the interaction planning control, the second prompt information being configured for indicating that the interaction range is in a plannable state; and controlling, in response to a moving operation on the any interaction range in the plannable state, the any interaction range to move.

In some embodiments, after any interaction range is updated and displayed based on a planning operation in response to the planning operation on the any interaction range, third prompt information of the planning operation is transmitted, in response to a confirmation operation on the planning operation, to the human-computer interaction interface that controls any virtual object, the third prompt information being configured for instructing to update any interaction range to an interaction range corresponding to the planning operation by controlling the any virtual object to move in the virtual scene.

In some embodiments, that third prompt information of the planning operation is transmitted, in response to a confirmation operation on the planning operation, to the human-computer interaction interface that controls any virtual object may be implemented in the following manner: displaying fourth prompt information in the virtual scene in response to the planning operation being completed, the fourth prompt information being configured for instructing to confirm the planning operation; and transmitting, in response to a confirmation operation on the fourth prompt information, the third prompt information of the planning operation to the human-computer interaction interface that controls any virtual object.

In some embodiments, when an interaction range of a target virtual object is displayed in the virtual scene, an intelligent planning control is displayed in the virtual scene. After the interaction range of the target virtual object is displayed in the virtual scene, fifth prompt information of a target interaction range of a candidate virtual object is transmitted, in response to a trigger operation on the intelligent planning control, to the human-computer interaction interface that controls the candidate virtual object, the candidate virtual object being at least one virtual object among the target virtual object, the target interaction range being an automatically determined new interaction range of the candidate virtual object, an area covered by the target interaction range of the candidate virtual object being larger than an area covered by the interaction range of the candidate virtual object, and the fifth prompt information being configured for instructing to update the interaction range of the candidate virtual object to the target interaction range by controlling the candidate virtual object to move in the virtual scene.

In some embodiments, that an intelligent planning control is displayed in the virtual scene may be implemented in the following manner: displaying, in the virtual scene in response to the target virtual object in the virtual scene being not planned, an intelligent planning control that is in a triggerable state; and displaying, in the virtual scene in response to the target virtual object in the virtual scene being planned, an intelligent planning control that is in a non-triggerable state, a display parameter of the intelligent planning control that is in the triggerable state being different from a display parameter of the intelligent planning control that is in the non-triggerable state.

In some embodiments, when the intelligent planning control is in the non-triggerable state, sixth prompt information is displayed in the virtual scene in response to a trigger operation on the intelligent planning control, the sixth prompt information being configured for indicating that the target virtual object in the virtual scene is being planned.

In some embodiments, when there are a plurality of candidate virtual objects, before the fifth prompt information of the target interaction range of the candidate virtual object is transmitted to the human-computer interaction interface that controls the candidate virtual object, a first interaction range and a second interaction range of each candidate virtual object are determined, the first interaction range being an interaction range having a largest coverage area, and the second interaction range being an interaction range having a second largest coverage area. In response to overlapping existing between the first interaction ranges of any two candidate virtual objects, the second interaction range of a first candidate virtual object is used as the target interaction range of the first candidate virtual object, and using the first interaction range of a second candidate virtual object as the target interaction range of the second candidate virtual object, the first candidate virtual object being a candidate virtual object with the largest second interaction range in the any two candidate virtual objects, and the second candidate virtual object being the other candidate virtual object in the any two candidate virtual objects except the first candidate virtual object; and the first interaction ranges of the any two candidate virtual objects is used as the target interaction ranges of the any two candidate virtual objects in response to no overlapping existing between the first interaction ranges of the any two candidate virtual objects.

In some embodiments, the candidate virtual object is at least one of the following: a virtual object selected from the target virtual object through a selection operation; a virtual object, which is configured for assisting in launching an attack, among the target virtual object; and a virtual object for which a number of planned operations exceeds a second number-of-times threshold.

The following describes exemplary application of this embodiment of this application in an actual application scene.

This embodiment of this application may be applied to various virtual scenes. For example, in a virtual scene such as a game, a real combat process between virtual objects can be simulated.

An example in which a virtual scene is a shooting game is used for description below.

In a related art, when a player has abundant materials and intends to push for rankings with a conservative tactic, the player may usually find an appropriate building or a high place of a landform to hold an angle. In this way, it can ensure safety of a team (also referred to as a virtual faction) and completeness of information in a battle as much as possible.

In an implementation process, the applicant has found that there are many problems in an angle holding process. Players cannot chat with each other about angle holding at all unless they open microphones. It is very easy for virtual objects controlled by the players to hold angles repeatedly. Second, even if a player has held an angle, the player cannot learn about holding angles of other virtual objects, and some prompts of angle holding positions lack for a newbie.

Therefore, the players cannot perform effective angle holding planning and communication. In view of this, an embodiment of this application provides an interaction processing method for a virtual scene, which can display a ballistic path (i.e. an attack trajectory) and an angle holding range during angle holding, automatically mark an enemy during attacking, and employ intelligent planning if no planning is performed. This meets all demands of a player for holding an angle, fills up the blank of a current angle holding mechanism, and enhances a user experience of a game.

The following describes the interaction processing method for the virtual scene provided in this embodiment of this application on the product side.

In this embodiment of this application, for the purpose of “making a team clearly know a holding angle, making a director perform angle holding planning and intelligent planning.” A UI (including a “team angle holding range” switch, an “angle holding planning” switch, and an “intelligent planning” button) of a “related items of angle holding” module is added at a left hand side of a large map. An angle holding range of a teammate is added on the large map (which is implemented through the UI). A ballistic illustration after a player fires a gun is added on the large map. A gesture of “dragging and rotating” is added on the large map. An actual angle holding range of a player is added in the virtual scene. An angle holding illustration recommended by the director and an angle holding illustration recommended intelligently are added in the virtual scene. A specific logic of the product side is as follows:

As shown in FIG. 6A, when a player opens a large map in a battle, a “related items of angle holding” module 601 (implemented through the UI) is displayed at a lower left corner of the large map. The “related items of angle holding” module 601 includes a text title “related items of angle holding” and a “team angle holding range” switch 602 (i.e. the above interaction range trigger control). The “team angle holding range” switch 602 is off by default, namely, an initial state.

As shown in FIG. 6A, in response to a click/tap operation on the “team angle holding range” switch, the “team angle holding range” switch is turned on, and an “angle holding planning” switch 603 (i.e. the above interaction planning control) and an “intelligent planning” button 604 (i.e. the above intelligent planning control) are displayed below the “team angle holding range” switch. In this case, the “angle holding planning” switch is off by default. An angle holding range 605 in a corresponding color is displayed on the large map based on a color of a serial number of the teammate. When a virtual object controlled by the player fires a gun, a gray ant line 606 is displayed on the large map to express a gun line trajectory of a virtual weapon. If the virtual weapon hits an enemy, point marking 607 is automatically performed on the enemy and is synchronized in the team.

The angle holding range is a field of view range of the virtual object when the virtual object holds the virtual weapon for aiming. As shown in FIG. 6B, the angle holding range includes a field of view angle range 6051 and a field of view distance 6052 in the field of view angle range. The angle holding range is a triangular region in which the virtual object controlled by the player is a vertex of an equilateral triangle (the field of view angle range 6051 is 60°) and a height (i.e. the field of view distance 6052) is 800 m. Certainly, the field of view angle range 6051 and the field of view distance 6052 may be adjusted based on a scale of a large map of each game. The field of view angle range 6051 and the field of view distance 6052 are not limited in this embodiment of this application.

As shown in FIG. 7, in response to a click/tap operation on the “angle holding planning” switch, the “angle holding planning” switch is turned on, and an ant line 701 with double arrows can be displayed within the angle holding range of the teammate in the team on the large map, to notify the player that the angle holding range can be moved.

As shown in FIG. 8A, in response to the angle holding range of the teammate on the large map being moved, the angle holding range becomes luminous yellow for prompting. Meanwhile, circular rotation is performed by using a current position of the teammate as a circle center. A rotation angle is kept consist with a movement angle of the player. When a moving gesture is released, prompt information 801 (TIPS) appears beside the moved angle holding range. If a “×” cancel control 802 in the prompt information 801 is clicked/tapped, the planning operation is canceled. If a “√” confirm control 803 in the prompt information 801 is clicked/tapped, prompt information (referred to as a planning prompt) of the planning operation is transmitted to a planned teammate, and the planning prompt is displayed on the large map of the planned teammate and in the virtual scene. The angle holding range displayed on the large map of the planner returns to an original state (the angle holding range shown in FIG. 6A or the angle holding range shown in FIG. 7), and a system prompt is provided, for example, a text prompt “planning on teammate 1 has been completed.”

For example, as shown in FIG. 8B, a planning prompt 804 is displayed in the virtual scene of the planned teammate. The planning prompt 804 is configured for prompting that the planned teammate can move based on the planning prompt 804.

If the planned teammate moves or waits for set duration (for example, 10 seconds), displaying of the planning prompt is canceled.

When there is another player is performing planning, the “intelligent planning” button may be gray and cannot be clicked/tapped. To be specific, the “intelligent planning” button is in the non-triggerable state. The “intelligent planning” button can be highlighted only when no player is performing planning. In response to the “intelligent planning” button being clicked/tapped, a system may calculate an angle holding recommendation (i.e. a new angle holding range) suitable for all the virtual objects based on an algorithm rule, transmits a planning prompt of the calculated angle holding recommendation to all the virtual objects, and displays the planning prompt of the calculated angle holding recommendation on the large maps and virtual scenes of all the virtual objects.

The following describes the interaction processing method for the virtual scene provided in this embodiment of this application on the technical side.

A core function of this embodiment of this application includes three functions, i.e. “team angle holding range,” “angle holding planning,” and “intelligent planning.” The three functions are associated with each other and affect each other. The three functions are separately described below.

First, with reference to a schematic logic diagram showing “team angle holding range” shown in FIG. 9, the “team angle holding range” function is described.
Operation 11: Determine whether a “team angle holding range” switch is triggered; perform operation 12 when the “team angle holding range” switch is triggered; and end the process when the “team angle holding range” switch is not triggered.

Herein, when a player opens a large map in a battle, a “related items of angle holding” module may be displayed at a lower left corner region. The “related items of angle holding” module includes a text title “related items of angle holding” and a “team angle holding range” switch. The “team angle holding range” switch is off by default.
Operation 12: Display an “angle holding planning” switch and an “intelligent planning” button, and display an angle holding range of a teammate on the large map.

Herein, if the “team angle holding range” switch is triggered, the “team angle holding range” switch is switched to Display. In addition, the “angle holding planning” switch and the “Intelligent planning” button are newly added below the “team angle holding range” switch, and the angle holding range of the teammate may be displayed on the large map.
Operation 13: Display a gun line trajectory of a virtual weapon on the large map when the teammate fires a gun.

Herein, if the teammate fires a gun, an ant line, i.e. the gun line trajectory, is formed by using a position of the teammate as an endpoint and a bullet shooting point as another endpoint, and the ant line is displayed on the large map.
Operation 14: Automatically perform point marking on an enemy when the virtual weapon hits the enemy.

Herein, if the virtual weapon hits the enemy, the enemy needs to be marked.

In the entire flow shown in FIG. 9, whether the “team angle holding range” switch is triggered again needs to be determined in real time. If the “team angle holding range” switch is triggered again, the “team angle holding range” switch is switched back to Hide and returns to an initial state. The angle holding range, the “angle holding planning” switch, and the “intelligent planning” button that are displayed on the large map are hidden.

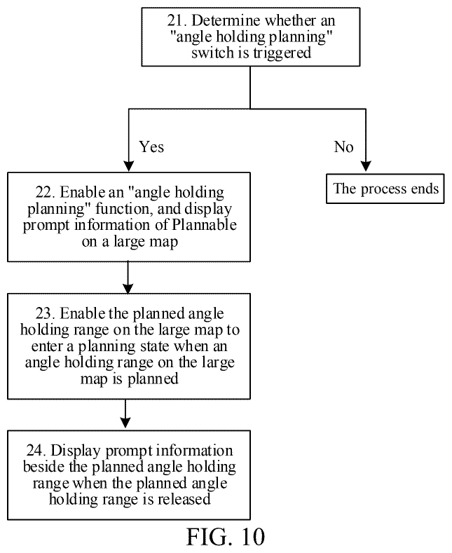

Then, with reference to a schematic logic diagram showing “angle holding planning” shown in FIG. 10, the “angle holding planning” function is described.
Operation 21: Determine whether an “angle holding planning” switch is triggered, perform operation 22 when the “angle holding planning” switch is triggered, and end the process when the “angle holding planning” switch is not triggered.

Herein, when the “team angle holding range” switch is turned on, whether the “angle holding planning” switch is clicked/tapped needs to be further determined.
Operation 22: Enable the “angle holding planning” function, and display prompt information of Plannable on a large map.

Herein, the “angle holding planning” switch is switched to Enable, and the prompt information of Plannable is displayed on the large map. For example, an ant line with double arrows may be displayed within an angle holding range of a teammate in a team on the large map.
Operation 23: Enable the planned angle holding range on the large map to enter a planning state when the angle holding range on the large map is planned.

Herein, the planning on the angle holding range is implemented in the following manner: whether a hot zone (i.e. a region corresponding to the angle holding range) is pressed and dragged is first determined; if the hot zone is dragged, the planned angle holding range (i.e. the angle holding range corresponding to the pressed hot zone) starts to enter the planning state, and the angle holding range entering the planning state becomes luminous yellow for prompting.
Operation 24: Display prompt information beside the planned angle holding range when the planned angle holding range is released.

Herein, when the planned angle holding range is released, namely, when a player releases a finger, the prompt information (TIPS) is displayed beside the planned angle holding range. If a “×” cancel control in the prompt information is clicked/tapped, this planning operation is canceled, namely, TIPS is hidden and the planning fails. No adjustment is made, and the process ends. If a “√” confirm control in the prompt information is clicked/tapped, the TIPS is hidden, the large map of the planner is restored to an original state. The planned teammate receives a planning prompt, and the “intelligent planning” button enters a non-triggerable state (i.e. a disabled state) because planning is being performed in the scene. If the planned teammate moves or waits for set duration (for example, 10 seconds), displaying of the planning prompt is canceled.

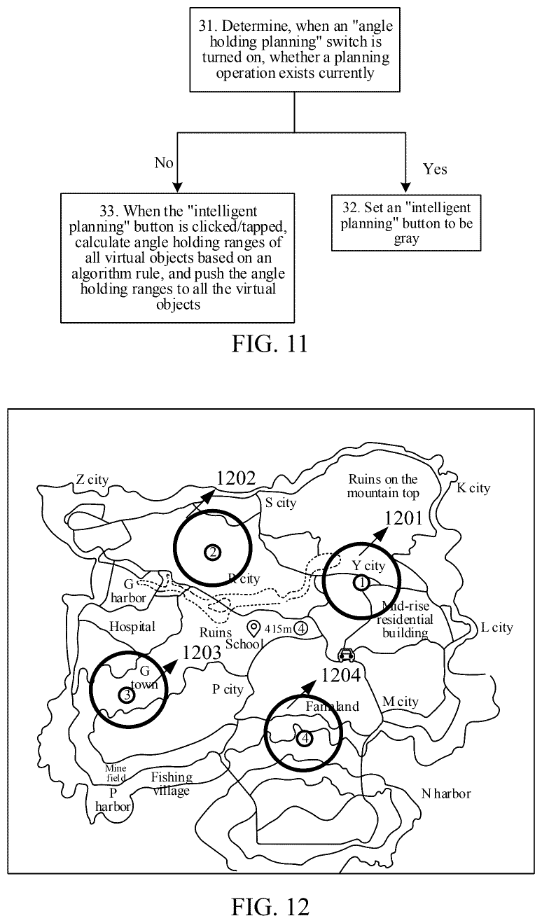

Finally, with reference to a schematic logic diagram showing “intelligent planning” shown in FIG. 11, the “intelligent planning” function is described.
Operation 31: Determine, when an “angle holding planning” switch is turned on, whether a planning operation exists currently, perform operation 32 when the planning operation exists, and perform operation 33 when the planning operation does not exist.

Herein, the planning operation represents an operation of planning a planning range in the scene.
Operation 32: Set the “intelligent planning” button to be gray.

Herein, when the planning operation still exists in the current scene, the “intelligent planning” button is displayed in gray, and the “intelligent planning” button displayed in gray is invalid after being triggered, and a system prompt pops up for prompting.
Operation 33: When the “intelligent planning” button is triggered, calculate angle holding ranges of all virtual objects based on an algorithm rule, and push the angle holding ranges to all the virtual objects.

Herein, when there is no planning operation in the scene, the “intelligent planning” button is highlighted. After the “intelligent planning” button is clicked/tapped, the angle holding ranges that are most suitable for all the virtual objects are calculated based on the algorithm rule, and are transmitted to all the virtual objects.

The following specifically describes the algorithm rule of “intelligent planning.”

The algorithm rule is calculated for the purpose of making “a maximum area that can be covered by a team member holding an angle.”

An example in which the angle holding range is a circle is used. First, a circle is drawn by using a current position of each teammate in the virtual scene as a circle center and employing a radius of 400 meters, to draw a region that can be covered by a team member holding an angle in an ideal case. As shown in FIG. 12, when there are four teammates, a circle 1201 is a region that can be covered by teammate 1 holding an angle in an ideal case; a circle 1202 is a region that can be covered by teammate 2 holding an angle in an ideal case; a circle 1203 is a region that can be covered by teammate 3 holding an angle in an ideal case; and a circle 1204 is a region that can be covered by teammate 4 holding an angle in an ideal case.

Then, an area that can be covered by each teammate holding an angle in 60° is calculated. Two cases in which no obstruction exists and an obstruction exists are described below:
Case 1. There is no obstruction for a teammate in an orientation.

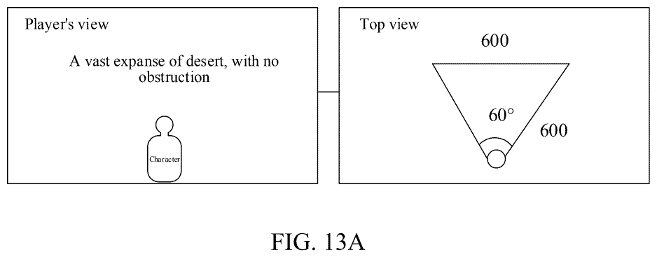

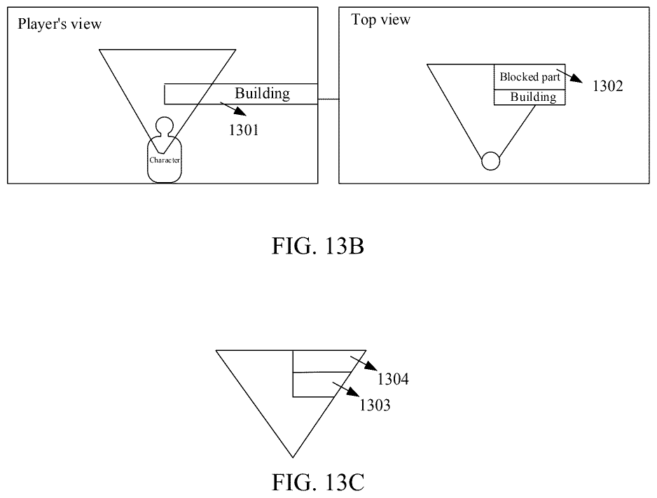

As shown in FIG. 13A, there is no obstruction for a virtual object in an orientation, and a region that can be covered by holding an angle is an equilateral triangle (i.e. a shape of an interaction range is an equilateral triangle). Therefore, it can be seen based on a calculation formula of an area of an isosceles triangle that an area that can be covered by a teammate holding an angle in an orientation of 60°is the area of the equilateral triangle, i.e. 600 (a length of a bottom edge) * 400 (a height)/2=1200000 m².
Case 2. There is an obstruction for a teammate in an orientation.

In this case, an area that can be covered by a teammate holding an angle in the orientation of 60° is equal to the area of the equilateral triangle—a coverage area of the obstruction—an area blocked by the obstruction.

As shown in FIG. 13B, if there is an obstruction 1301 for a virtual object in an orientation, a part 1302 blocked by the obstruction cannot be covered. To be specific, a field of view cannot reach the part 1302 when a teammate holds an angle. Therefore, as shown in FIG. 13C, to calculate an area that can be covered by the teammate holding an angle in the orientation of 60°, a coverage area 1303 of the obstruction and an area 1304 blocked by the obstruction need to be excluded.

Next, an angle holding range with a largest coverage area of each teammate is determined, and the angle holding range with the largest coverage area is used as an optimal solution of the teammate. An angle holding range having a second largest coverage area of each teammate is determined, and the angle holding range having the second largest coverage area is used as a suboptimal solution of the teammate.

Finally, whether the optimal solutions of teammates overlap is determined. When the optimal solutions of the teammates overlap, a maximum value among the suboptimal solutions of the teammates having the overlapping is determined, and the angle holding range corresponding to the maximum value is updated to a suboptimal solution, thus determining angle holding recommendations of all the teammates. In this case, an angle holding areas between teams reaches a maximum value.

In conclusion, according to the interaction processing method for the virtual scene provided in this embodiment of this application, after an “angle holding display” function is enabled, current angle holding ranges of teammates can be displayed on the large map, and angle holding ranges that can be reached by the teammates can be displayed in the virtual scene, so that a place on which angle holding is performed and a place on which angle holding is performed repeatedly can be clearly seen. Then, after a teammate fires a gun, a gun line trajectory can be synchronized to all the teammates, so that a shooting destination can be significantly known, and an enemy that has been hit can be automatically marked with a point. Then, if a player hoping to command can perform angle holding planning. After a plan is determined, a planned teammate can see corresponding prompts on the large map and in the scene. Finally, after “intelligent planning” is employed, the system can determine a current optimal angle holding range of each teammate based on the algorithm rule. In this way, all requirements of a player for an entire flow of holding an angle in a game are met, so that the player can more conveniently, quickly, and intelligently hold an angle in a game process, thereby improving competitiveness of the game, reducing a threshold for the player to hold an angle, and promoting team communication in the game. In addition, the entire system can complete all the operations by only requiring the player to click/tap and drag two existing interaction gestures, and can complete the functions of all the operations through the intelligent planning, without any other complex interaction operations and understandings, thereby reducing learning costs of the player, enhancing a user experience, and facilitating the player to better experience a core battle.

The interaction processing method for the virtual scene provided by the embodiments of this application has been described in conjunction with the exemplary applications and implementations of the electronic device provided by the embodiments of this application. The following continues to describe cooperation of modules in an interaction processing apparatus 555 for a virtual scene and an interaction processing apparatus 655 for a virtual scene, which are provided by the embodiments of this application to implement an interaction processing solution for a virtual scene.

The interaction processing apparatus 555 for the virtual scene includes: a first display module 5551, configured to display the virtual scene on a human-computer interaction interface, the virtual scene including a plurality of virtual objects; a second display module 5552, configured to display a map in the virtual scene in response to a displaying trigger operation for the map of the virtual scene; and a first interaction module 5553, configured to display an interaction range of a target virtual object on the map in response to an interaction condition being satisfied, the target virtual object being at least one of the plurality of virtual objects, and the interaction range being a range within which a virtual weapon held by the target virtual object is able to attack.

In some embodiments, the interaction condition includes one of the following: the displaying trigger operation for the interaction range is received; a quantity of virtual objects that launch an attack with the virtual weapon in the virtual scene reaches a first quantity threshold; a virtual object that is in a same virtual faction as a first virtual object is under attack, the first virtual object being a controlled virtual object on the human-computer interaction interface; a number of times that an account controlling the first virtual object performs the displaying trigger operation reaches a first number-of-times threshold; and a prediction instruction that is returned by a neural network model and is for displaying the interaction range is received.

In some embodiments, the prediction instruction is obtained by the neural network model performing the following processing: calling the neural network model for prediction based on an account feature of the account controlling the first virtual object and scene data of the virtual scene, to obtain the prediction instruction for displaying the interaction range; and the neural network model is obtained by training an account feature sample of an account sample, a scene data sample, and a prediction instruction annotation.

In some embodiments, the first interaction module 5553 is further configured to: display an interaction range trigger control in the virtual scene, and determine a trigger operation on the interaction range trigger control as the displaying trigger operation; or, display, in the virtual scene, first prompt information for the displaying of the interaction range, and determine a confirmation operation on the first prompt information as the displaying trigger operation.

In some embodiments, the interaction range includes an attack angle range that uses a current orientation of the target virtual object as a center line and an attack distance in the attack angle range; and the attack angle range is an angle range within which the virtual weapon held by the target virtual object can attack.

In some embodiments, the target virtual object is the virtual object that is in the same virtual faction as the first virtual object, and the first virtual object is a controlled virtual object on the human-computer interaction interface. The first interaction module 5553 is further configured to: display an identifier of the target virtual object on the map, and display interaction ranges corresponding to different identifiers based on different first display parameters, the first display parameters including at least one of the following: a color, a size, a shape, and an effect.

In some embodiments, the target virtual object includes an alliance virtual object and an opposing virtual object. The alliance virtual object is the virtual object that is in the same virtual faction as the first virtual object, and the opposing virtual object is the virtual object that is in the opposing virtual faction of the first virtual object. The first virtual object is the controlled virtual object on the human-computer interaction interface. The first interaction module 5553 is further configured to display an interaction range of the opposing virtual object on the map based on a second display parameter, the second display parameter being distinguished from a display parameter used by an interaction range of the alliance virtual object, and the second display parameter including at least one of the following: a color, a size, a shape, and an effect.

In some embodiments, before displaying the interaction range of the target virtual object on the map, the first interaction module 5553 is further configured to: display, in the virtual scene, a plurality of candidate types of virtual objects on which interaction ranges are to be displayed; and use a virtual object of a selected candidate type as the target virtual object in response to a selection operation on the candidate types.

In some embodiments, after displaying the interaction range of the target virtual object on the map, the first interaction module 5553 is further configured to: in response to any virtual object holding the virtual weapon among the target virtual object to complete the attack, display, within the interaction range of the any virtual object, an attack trajectory of the virtual weapon held by the any virtual object; and display a mark of a target on the map in response to the virtual weapon held by the any virtual object hitting the target.

In some embodiments, after displaying the interaction range of the target virtual object on the map, the first interaction module 5553 is further configured to update and display any interaction range based on a planning operation in response to the planning operation on the any interaction range, the any interaction range being the interaction range of any virtual object among the target virtual object.

In some embodiments, the first interaction module 5553 is further configured to: display an interaction planning control in the virtual scene; display second prompt information of the interaction range of the target virtual object in response to a trigger operation on the interaction planning control, the second prompt information being configured for indicating that the interaction range is in a plannable state; and control, in response to a moving operation on the any interaction range in the plannable state, the any interaction range to move.

In some embodiments, after updating and displaying any interaction range based on the planning operation in response to the planning operation on the any interaction range, the first interaction module 5553 is further configured to: transmit, in response to a confirmation operation on the planning operation, third prompt information of the planning operation to the human-computer interaction interface that controls any virtual object, the third prompt information being configured for instructing to update any interaction range to an interaction range corresponding to the planning operation by controlling the any virtual object to move in the virtual scene.

In some embodiments, the first interaction module 5553 is further configured to: display fourth prompt information on the map in response to the planning operation being completed, the fourth prompt information being configured for instructing to confirm the planning operation; and transmit, in response to a confirmation operation on the fourth prompt information, the third prompt information of the planning operation to the human-computer interaction interface that controls any virtual object.

In some embodiments, when displaying the interaction range of the target virtual object on the map, the first interaction module 5553 is further configured to: display an intelligent planning control in the virtual scene. After displaying the interaction range of the target virtual object on the map, the first interaction module 5553 is further configured to transmit in response to a trigger operation on the intelligent planning control, fifth prompt information of a target interaction range of a candidate virtual object to the human-computer interaction interface that controls the candidate virtual object, the candidate virtual object being at least one virtual object among the target virtual object, the target interaction range being an automatically determined new interaction range of the candidate virtual object, an area covered by the target interaction range of the candidate virtual object being larger than an area covered by the interaction range of the candidate virtual object, and the fifth prompt information being configured for instructing to update the interaction range of the candidate virtual object to the target interaction range by controlling the candidate virtual object to move in the virtual scene.

In some embodiments, the first interaction module 5553 is further configured to: display, in the virtual scene in response to the target virtual object on the map being not planned, an intelligent planning control that is in a triggerable state; and display, in the virtual scene in response to the target virtual object on the map being planned, an intelligent planning control that is in a non-triggerable state, a display parameter of the intelligent planning control that is in the triggerable state being different from a display parameter of the intelligent planning control that is in the non-triggerable state.

In some embodiments, when the intelligent planning control is in the non-triggerable state, the first interaction module 5553 is further configured to display sixth prompt information in the virtual scene in response to a trigger operation on the intelligent planning control, the sixth prompt information being configured for indicating that the target virtual object on the map is being planned.

In some embodiments, when a plurality of candidate virtual objects are provided, before transmitting, in response to the trigger operation on the intelligent planning control, the fifth prompt information of the target interaction range of the candidate virtual object to the human-computer interaction interface that controls the candidate virtual object, the first interaction module 5553 is further configured to: determine a first interaction range and a second interaction range of each candidate virtual object, the first interaction range being an interaction range having a largest coverage area, and the second interaction range being an interaction range having a second largest coverage area; in response to overlapping existing between the first interaction ranges of any two candidate virtual objects, use the second interaction range of a first candidate virtual object as the target interaction range of the first candidate virtual object, and use the first interaction range of a second candidate virtual object as the target interaction range of the second candidate virtual object, the first candidate virtual object being a candidate virtual object with the largest second interaction range in the any two candidate virtual objects, and the second candidate virtual object being the other candidate virtual object in the any two candidate virtual objects except the first candidate virtual object; and use the first interaction ranges of the any two candidate virtual objects as the target interaction ranges of the any two candidate virtual objects in response to no overlapping existing between the first interaction ranges of the any two candidate virtual objects.

The apparatus 655 includes: a third display module 6551, configured to display the virtual scene on a human-computer interaction interface, the virtual scene including a plurality of virtual objects; a second interaction module 6552, configured to display an interaction range of a target virtual object in the virtual scene in response to an interaction condition being satisfied, the target virtual object being at least one of the plurality of virtual objects, and the interaction range being a range within which a virtual weapon held by the target virtual object is able to attack.

An embodiment of this application provides a computer program product. The computer program product includes a computer program or a computer-executable instruction. The computer program or computer-executable instruction is stored in a computer-readable storage medium. A processor of an electronic device reads the computer program or the computer-executable instruction from the computer-readable storage medium, and the processor executes the computer program or the computer-executable instruction to cause the electronic device to perform the interaction processing method for the virtual scene in the embodiments of this application.

An embodiment of this application provides a computer-readable storage medium, having a computer-executable instruction or a computer program stored therein. When the computer-executable instruction or the computer program is executed by a processor, the processor is caused to perform the interaction processing method for the virtual scene provided in the embodiments of this application, for example, the interaction processing method for the virtual scene shown in FIG. 4A.

In some embodiments, the computer-readable storage medium may be a memory such as a ferroelectric random access memory (FRAM), a ROM, a programmable read-only memory (PROM), an erasable programmable read-only memory (EPROM), an electrically erasable programmable read-only memory (EEPROM), a flash memory, a magnetic surface memory, an optical disc, or a compact disc (CD)-ROM, or may be one of the above memories or any combined device.

In some embodiments, the computer-executable instructions may be written in the form of program, software, software module, script, or code in any form of programming language (including compilation or interpretation language, or declarative or procedural language), and the computer executable instructions may be deployed in any form, including being deployed as an independent program or being deployed as a module, component, subroutine, or another unit suitable for use in a computing environment.

In an example, the computer-executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

As an example, the computer-executable instructions may be deployed to be executed on one electronic device, on a plurality of electronic devices located at one site, or on a plurality of electronic devices distributed at a plurality of locations and connected by a communication network.

The foregoing descriptions are merely embodiments of this application and are not intended to limit the scope of this application. Any modification, equivalent replacement, or improvement made within the spirit and scope of this application fall within the scope of this application.

What is claimed is:

1. An interaction processing method, performed by an electronic device, comprising:
displaying a virtual scene on a human-computer interaction interface, the virtual scene including a plurality of virtual objects; and
displaying an interaction range of a target virtual object of the plurality of virtual objects in the virtual scene in response to an interaction condition being satisfied, the interaction range being a range within which a virtual weapon held by the target virtual object is able to attack.

2. The method according to claim 1, further comprising:
displaying a map in the virtual scene in response to a map displaying trigger operation for the map of the virtual scene;
wherein displaying the interaction range includes displaying the interaction range on the map.

3. The method according to claim 2, wherein the interaction condition includes one of following:
a range displaying trigger operation for the interaction range is received;
a quantity of virtual objects that launch an attack with virtual weapons in the virtual scene reaches a quantity threshold;
a virtual object that is in a same virtual faction as a controlled virtual object on the human-computer interaction interface is under attack;
a number of times that an account controlling the controlled virtual object performs the range displaying trigger operation reaches a number-of-times threshold; and
a prediction instruction returned by a neural network model for displaying the interaction range is received.

4. The method according to claim 3, wherein:
the prediction instruction is obtained by calling the neural network model for prediction based on an account feature of the account controlling the controlled virtual object and scene data of the virtual scene, to obtain the prediction instruction for displaying the interaction range; and
the neural network model is obtained by training an account feature sample of an account sample, a scene data sample, and a prediction instruction annotation.

5. The method according to claim 3, further comprising:
displaying an interaction range trigger control in the virtual scene, and determining a trigger operation on the interaction range trigger control as the range displaying trigger operation; and/or
displaying, in the virtual scene, prompt information for displaying of the interaction range, and determining a confirmation operation on the prompt information as the range displaying trigger operation.

6. The method according to claim 2, wherein:
the target virtual object is in a same virtual faction as a controlled virtual object on the human-computer interaction interface; and
displaying the interaction range includes:
displaying an identifier of the target virtual object on the map, and displaying the interaction range based on a display parameter, the display parameter including at least one of color, size, shape, or effect.

7. The method according to claim 2, wherein:
the target virtual object is one of a plurality of target virtual objects that include an alliance virtual object and an opposing virtual object, the alliance virtual object being in a same virtual faction as a controlled virtual object on the human-computer interaction interface, and the opposing virtual object being in an opposing virtual faction of the controlled virtual object; and
displaying the interaction range includes:
displaying an interaction range of the alliance virtual object on the map based on a first display parameter, the first display parameter including at least one of color, size, shape, or effect; and
displaying an interaction range of the opposing virtual object on the map based on a second display parameter distinguished from the first display parameter, the second display parameter including at least one of color, size, shape, or effect.

8. The method according to claim 2, further comprising, before displaying the interaction range:
displaying, in the virtual scene, a plurality of candidate types; and
in response to one candidate type of the plurality of candidate type being selected, determining a virtual object of the one candidate type as the target virtual object.

9. The method according to claim 2, further comprising, after displaying the interaction range:
in response to the target virtual object completing an attack, displaying, within the interaction range, an attack trajectory of the virtual weapon held by the target virtual object; and
displaying a mark of a target on the map in response to the virtual weapon held by the target virtual object hitting the target.

10. The method according to claim 2, further comprising, after displaying the interaction range:
in response to a planning operation on the interaction range, updating and displaying the interaction range based on the planning operation.

11. The method according to claim 10, wherein in response to the planning operation on the interaction range, updating and displaying the interaction range based on the planning operation includes:
displaying an interaction planning control in the virtual scene;
displaying prompt information of the interaction range in response to a trigger operation on the interaction planning control, the prompt information indicating that the interaction range is in a plannable state; and
controlling, in response to a moving operation on the interaction range in the plannable state, the interaction range to move.

12. The method according to claim 10, further comprising, after updating and displaying the interaction range based on the planning operation:
transmitting, in response to a confirmation operation on the planning operation, prompt information of the planning operation to a human-computer interaction interface that controls the target virtual object, the prompt information instructing to update the interaction range to an interaction range corresponding to the planning operation by controlling the target virtual object to move in the virtual scene.

13. The method according to claim 12, wherein:
the prompt information is first prompt information; and
transmitting, in response to the confirmation operation on the planning operation, the first prompt information to the human-computer interaction interface that controls the target virtual object includes:
displaying second prompt information on the map in response to the planning operation being completed, the second prompt information instructing to confirm the planning operation; and
transmitting, in response to a confirmation operation on the second prompt information, the first prompt information to the human-computer interaction interface that controls the target virtual object.

14. The method according to claim 2,
wherein the target virtual object is one of one or more target virtual objects each with an interaction range being displayed on the map in response to the interaction condition being satisfied;
the method further comprising:
while displaying the interaction range:
displaying an intelligent planning control in the virtual scene; and after displaying the interaction range:
transmitting, in response to a trigger operation on the intelligent planning control, prompt information of a target interaction range of a candidate virtual object to a human-computer interaction interface that controls the candidate virtual object, the candidate virtual object being one of the one or more target virtual objects, the target interaction range being an automatically determined new interaction range of the candidate virtual object, an area covered by the target interaction range being larger than an area covered by the interaction range of the candidate virtual object, and the prompt information instructing to update the interaction range of the candidate virtual object to the target interaction range by controlling the candidate virtual object to move in the virtual scene.

15. The method according to claim 14,
wherein the candidate virtual object is one of a plurality of candidate virtual objects provided;
the method further comprising, before transmitting the prompt information:
determining a first interaction range and a second interaction range of each candidate virtual object, the first interaction range covering a larger area than the second interaction range, the plurality of candidate virtual objects including a first candidate virtual object and a second candidate virtual object, and the second interaction range of the first candidate virtual object being larger than the second interaction range of the second candidate virtual object; and
for the first candidate virtual object and the second candidate virtual object:
in response to the first interaction range of the first candidate virtual object and the first interaction range of the second candidate virtual object overlapping each other, determining the second interaction range of the first candidate virtual object as the target interaction range of the first candidate virtual object, and determining the first interaction range of the second candidate virtual object as the target interaction range of the second candidate virtual object; and
in response to the first interaction range of the first candidate virtual object and the first interaction range of the second candidate virtual object not overlapping each other, determining the first interaction range of the first candidate virtual object as the target interaction range of the first candidate virtual object, and determining the first interaction range of the second candidate virtual object as the target interaction range of the second candidate virtual object.

16. The method according to claim 14, wherein the candidate virtual object is at least one of:
a virtual object selected from the one or more target virtual object through a selection operation,
a virtual object, configured to assist in launching an attack, among the one or more target virtual objects; and
a virtual object for which a number of planned operations exceeds a number-of-times threshold.

17. The method according to claim 2, further comprising:
displaying, in the virtual scene in response to the target virtual object on the map being not planned, a first intelligent planning control that is in a triggerable state and has a first display parameter; and
displaying, in the virtual scene in response to the target virtual object on the map being planned, a second intelligent planning control that is in a non-triggerable state and has a second display parameter different from the first display parameter.

18. The method according to claim 2, further comprising:
displaying an intelligent planning control that is in a non-triggerable state in the virtual scene; and
displaying prompt information in the virtual scene in response to a trigger operation on the intelligent planning control, the prompt information indicating that the target virtual object on the map is being planned.

19. An electronic device comprising:
a memory storing a computer program or a computer-executable instruction; and
a processor configured to execute the computer program or the computer-executable instruction to:
display a virtual scene on a human-computer interaction interface, the virtual scene including a plurality of virtual objects; and
display an interaction range of a target virtual object of the plurality of virtual objects in the virtual scene in response to an interaction condition being satisfied, the interaction range being a range within which a virtual weapon held by the target virtual object is able to attack.

20. A non-transitory computer-readable storage medium storing a computer program or a computer-executable instruction that, when executed by a processor, causes an electronic device including the processor to:
display a virtual scene on a human-computer interaction interface, the virtual scene including a plurality of virtual objects; and
display an interaction range of a target virtual object of the plurality of virtual objects in the virtual scene in response to an interaction condition being satisfied, the interaction range being a range within which a virtual weapon held by the target virtual object is able to attack.
